(19) United States
(12) Patent Application Publication
(10) Pub. No.: US 2024/0226951 A1
(43) Pub. Date: Jul. 11, 2024

(54) Insulating Liquid Supply Apparatus

(71) Applicant: LG Energy Solution, Ltd., Seoul (KR)

(72) Inventors: Joon Sun Park, Daejeon (KR); Guk Tae Kim, Daejeon (KR); Man Hyeong Kim, Daejeon (KR); Min Hyuck Choi, Daejeon (KR)

(73) Assignee: LG Energy Solution, Ltd., Seoul (KR)

(21) Appl. No.: 18/561,858

(22) PCT Filed: Mar. 17, 2023
(86) PCT No.: PCT/KR2023/003606

§ 371 Date: Nov. 17, 2023

(30) Foreign Application Priority Data
Mar. 17, 2022 (KR) 10-2022-0033402

(51) Int. Cl. B05C 11/10; B05C 5/02

(52) U.S. Cl. CPC B05C 11/10; B05C 5/0254

(57) ABSTRACT

An insulating liquid supplying device includes an insulating liquid tank for receiving insulating liquid, a slot die for discharging insulating liquid to the outside, and an insulating liquid header located at the upper part of the slot die for conveying insulating liquid transferred from the insulating liquid tank to the slot die. A pipe connecting the insulating liquid tank, slot die, and insulating liquid header permits transfer of the insulating liquid, and a transfer pump is provided in the pipe to transfer insulating liquid from the insulating liquid tank to the slot die.

### CROSS-REFERENCE TO RELATED APPLICATIONS

The present application is a national phase entry under 35 U.S.C. § 371 of International Application No. PCT/KR2023/003606 filed Mar. 17, 2023, which claims the benefit of Korean Patent Application No. 10-2022-0033402 filed on Mar. 17, 2022, the entire contents of which are incorporated herein by reference.

### TECHNICAL FIELDS

The present invention relates to an insulating liquid supplying device suitable for multi-row simultaneous coating of an insulating liquid.

### BACKGROUND

Lithium secondary batteries and similar batteries utilize electrodes having an active material and an insulating layer formed on the surface of a current collector. These electrodes are manufactured by applying both an electrode slurry containing an active material and an insulating liquid containing an insulating material to the surface of the collector using a coating device, such as a slot die, and drying it such that some of the edges of the electrode composite layer overlap.

The insulating liquid is applied over both edges in the width direction of the electrode slurry applied to the current collector, and when the electrode slurry is applied to the electrodes in multiple rows, the insulating liquid is also applied in multiple rows. For multi-row simultaneous coatings, such as the coating shown in FIG. 1, a plurality of transfer pipes are connected in parallel to the slot die from the insulating liquid tank storing the insulating liquid, and a transfer pump is provided for each transfer pipe for transferring the insulating liquid.

Continuing with the prior art shown in FIG. 1, even if all the transfer pumps 300′ transport a certain flow rate, differences in the flow rate of the insulating liquid 10′ delivered to the slot die 400′ from each of the transfer pipes 200′ may occur due to differences in the distance from the insulating liquid tank 100′ to the transfer pumps 300′, the length of the transfer pipes 200′, and the distance from the transfer pumps 300′ to the slot die 400′, etc. For example, the flow rate of the insulating liquid 10′ from the transfer pipe 200′ with the greatest pressure loss may be significantly reduced.

Furthermore, it is difficult for all transfer pumps to transfer the same flow rate of insulating liquid, which can further increase the unevenness of the insulating liquid that is finally discharged from the slot die. Setting the discharge flow rate of each transfer pump individually in consideration of the flow unevenness is difficult to manage.

### DESCRIPTION OF THE INVENTION

### Technical Problem

The present invention aims to improve flow rates and qualities of insulating liquid in a device for supplying insulating liquid to a slot die for multi-row simultaneous coating.

Other objects and advantages of the present invention can be understood from the following description, and will become more apparent from the exemplary embodiments of the present invention. It will also be readily apparent that the objects and advantages of the present invention can be implemented by the combinations thereof set forth in the claims of the patent.

### Technical Solution

To solve the above-mentioned problems,

According to the present invention, an insulating liquid supplying device for supplying insulating liquid to a slot die for a multi-row simultaneous coating includes: an insulating liquid tank for receiving insulating liquid; a cylindrical insulating liquid header receiving insulating liquid transferred from the insulating liquid tank, and conveying the received insulating liquid to a slot die; a transfer pipe connected between the insulating liquid tank and the insulating liquid header so that insulating liquid can be transferred; a plurality of supply pipes connected between the insulating liquid header and the slot die; and a transfer pump provided in the transfer pipe to provide pressure to transfer insulating liquid from the insulating liquid tank to the slot die, wherein the supply pipes are connected to the upper part of the insulating liquid header.

Specifically, the insulating liquid header may extend along the width direction of the slot die.

In addition, the insulating liquid header may be formed to be extended so that it can be horizontal to the slot die.

In addition, the supply pipe may be protruded from the upper part of the insulating liquid header and connected to the slot die.

More specifically, the plurality of supply pipes may be disposed along the direction in which the insulating liquid header is extended to connect the insulating liquid header and the slot die.

In addition, the length and inside diameter of each of the supply pipes may be all the same.

In addition, the pressure losses in each of the supply pipes may be the same.

Meanwhile, the pressure loss of the insulating liquid header may be smaller than the pressure loss of the supply pipe.

In addition, the pressure losses of the insulating liquid header and the supply pipe may meet the conditions of Equation 1 below.

$$( Δ Ph / n ) < Δ Ps * 5 \% \qquad [ Equation 1 ]$$

(In Equation 1, n is the number of transfer pipes connected to the insulating liquid header, ΔPh is the pressure loss inside the insulating liquid header, and ΔPs is the pressure loss of a single supply pipe.)

In addition, the transfer pipe may be connected to the lower part of the insulating liquid header.

Meanwhile, according to another exemplary embodiment, the transfer pipe may include: a main transfer pipe connected to the insulating liquid tank; and an auxiliary transfer pipe branching from the main transfer pipe and connected to the insulating liquid header.

Specifically, at least two or more auxiliary transfer pipes branch off in parallel from the main transfer pipe, and the branched auxiliary transfer pipes are connected to the insulating liquid header, respectively.

More specifically, the transfer pumps may be provided in each of the auxiliary transfer pipes.

According to the present invention, a slot die including a plurality of outlets for discharging insulating liquid at one end, connected to an insulating liquid header receiving the insulating liquid, and receiving insulating liquid from each supply pipe by being connected to the insulating liquid header by a plurality of supply pipes is provided.

### Advantageous Effects

According to the present invention, the flow rate of the insulating liquid transferred to the slot die through the plurality of pipes has little variation. Furthermore, the discharge pressure of each insulating liquid discharged from the slot die through the plurality of nozzles can be maintained uniformly.

### BRIEF DESCRIPTION OF THE DRAWINGS

FIG. 1 is a perspective view of a conventional insulating coating liquid supplying device for multi-row simultaneous coating according to the prior art.

FIG. 2 is a perspective view of an insulating liquid supplying device according to one embodiment of the present invention.

FIG. 3 is a top view of an insulating liquid header of an insulating liquid supplying device according to one embodiment of the present invention.

FIG. 4 is a cross-sectional view of the insulating liquid header of FIG. 3.

FIG. 5 is a perspective view of insulating liquid supplying device according to another embodiment of the present invention.

FIG. 6 is a perspective view of an insulating liquid supplying device according to another embodiment of the present invention.

FIG. 7 is a perspective view of an insulating liquid supplying device according to a fourth embodiment of the present invention.

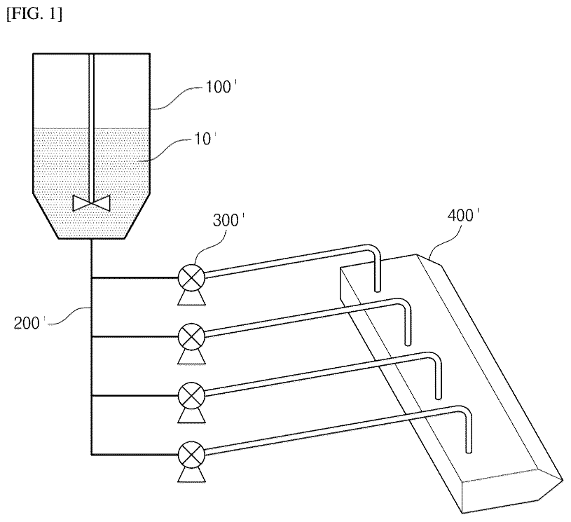

### DETAILED DESCRIPTION OF THE PREFERRED EMBODIMENTS

Hereinafter, the present invention is described in detail with reference to the accompanying drawings and various embodiments. The exemplary embodiments described herein are shown by way of illustration to aid in understanding the invention, and the accompanying drawings are not to scale and may show exaggerated dimensions of some components.

The present invention is subject to various modifications and may take many forms, and certain embodiments are illustrated in the drawings and described in detail herein. However, this disclosure is not intended to limit the invention to any particular disclosed form and is to be understood to include all modifications, equivalents, or substitutions that fall within the scope of the present invention and technology.

The insulating liquid supplying device 100 according to embodiments of the present invention supplies insulating liquid 10 to a slot die 200 for multi-row simultaneous coating that can simultaneously provide insulating liquid to both sides of an electrode active material. In other words, the present invention relates to a device for supplying insulating liquid 10 to a slot die 200 that coats by simultaneously discharging insulating liquid 10 in a plurality of rows.

Specifically, the insulating liquid supplying device 100 of the present invention includes an insulating liquid tank 110, an insulating liquid header 120, a transfer pipe 130, a supply pipe 140, and a transfer pump 150, and it uniformly delivers the insulating liquid 10 transferred from the insulating liquid tank 110 by the insulating liquid header 120 to the slot die 200 through the supply pipe 140.

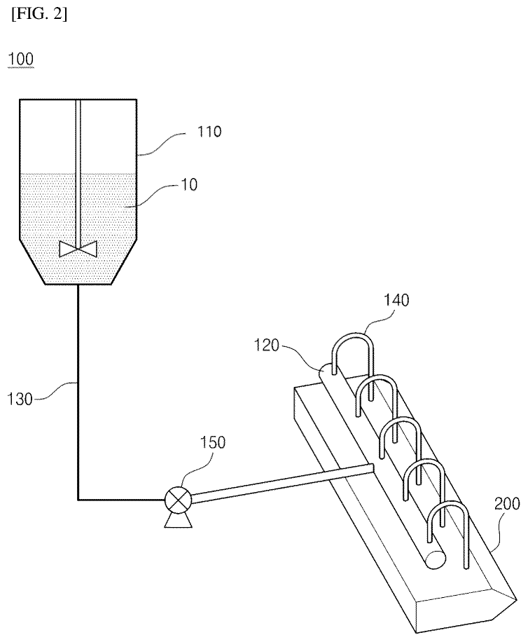

Hereinafter, an insulating liquid supplying device 100 of the embodiments of the present invention will be described with reference to FIGS. 2 through 7.

### First Embodiment

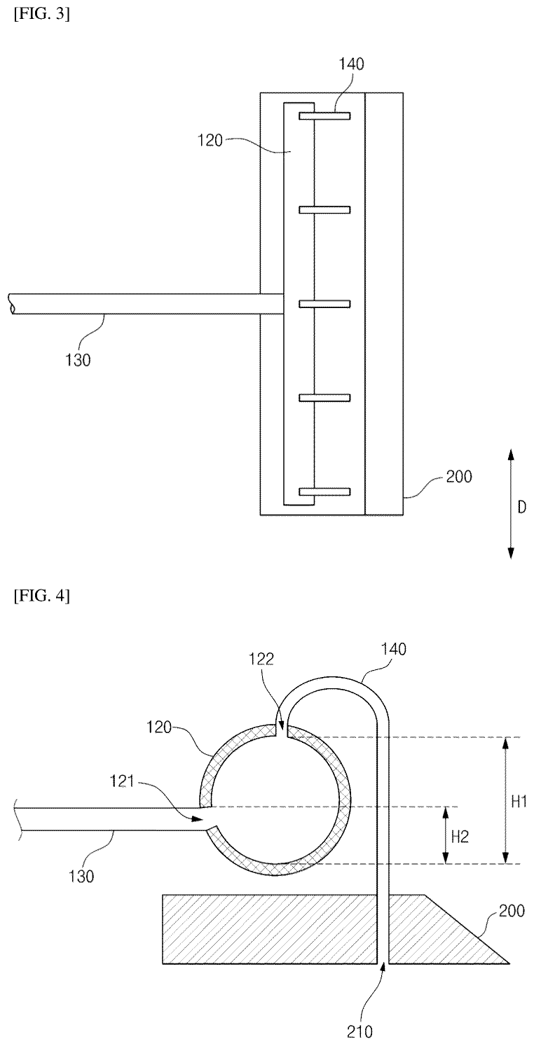

FIG. 2 illustrates an insulating liquid supplying device 100 according to a first embodiment of the present invention, FIG. 3 is a plan view of an insulating liquid header 120 of the insulating liquid supplying device 100 of FIG. 2, and FIG. 4 is a cross-sectional view of the insulating liquid header 120 of FIG. 3.

As shown in FIG. 2, the insulating liquid supplying device 100 according to the first embodiment of the present invention includes an insulating liquid tank 110, an insulating liquid header 120, a transfer pipe 130, a supply pipe 140, and a transfer pump 150.

The insulating liquid tank 110 receives the insulating liquid 10 required for coating, and discharges a certain amount of the received insulating liquid 10 and delivers it to the slot die 200. The insulating liquid tank 110 may be further provided with a stirrer or the like for stirring the received insulating liquid 10, and the stirrer may include an impeller and a stirring motor for driving the impeller.

A lower part of the insulating liquid tank 110 includes an outlet (not shown) through which the insulating liquid 10 is discharged, the outlet being connected to a transfer pipe 130 which serves as a transportation passage for the insulating liquid 10.

The insulating liquid 10 discharged from the insulating liquid tank 110 can be moved to the slot die 200 by an external pressure.

In the insulating liquid supplying device 100 of the present embodiment, the transfer pump 150 provided in the transfer pipe 130 can provide external pressure, that is, the insulating liquid 10 received in the insulating liquid tank 110 can be moved to the other side through the transfer pipe 130 by the pumping pressure exerted by the transfer pump 150.

Depending on the pumping pressure provided by the transfer pump 150, the flow rate of the insulating liquid 10 to be transferred may vary. In addition, the degree of pressure loss may vary depending on the length and inner diameter size of the transfer pipe 130. That is, even if the same pumping pressure is applied, the length of the transfer pipe 130 and the inner diameter size of the transfer pipe 130 may affect the flow rate of the insulating liquid 10.

The slot die 200 for multi-row simultaneous coating used in the present embodiment forms an insulating layer by discharging the insulating liquid 10 in a plurality of rows, respectively. Therefore, the slot die 200 may be provided with a plurality of discharge outlets (or nozzles), and each of the discharge outlet is connected to a corresponding discharge furnace 210.

The slot die 200 for multi-row simultaneous coating has an advantage that a plurality of insulating layers can be formed in a single, highly efficient operation. However, if the flow rate of the insulating liquid 10 simultaneously discharged through each discharge outlet is different, the loading amount of the insulating layer formed by the slot die 200 may not be uniform. Therefore, it is desirable that the inner diameter and length of each discharge furnace 210 formed in the slot die 200 are the same.

The insulating liquid header 120 receives the insulating liquid 10 transferred from the insulating liquid tank 110, and delivers the received insulating liquid 10 to the slot die 200.

The insulating liquid header 120 and the insulating liquid tank 110 are connected by a transfer pipe 130, and the insulating liquid 10 received in the insulating liquid tank 110 may be transferred to the insulating liquid header 120 through the transfer pipe 130.

In addition, the insulating liquid header 120 and the slot die 200 are connected by a supply pipe 140, and the insulating liquid 10 received in the insulating liquid header 120 can be transferred to the slot die 200 through the supply pipe 140. At this time, the supply pipe 140 connected to the slot die 200 is specifically connected to the discharge furnace 210 of the slot die 200. That is, the number of supply pipes 140 connected to the slot die 200 may be limited by the number of discharge furnaces 210 formed in the slot die 200.

The insulating liquid header 120 is preferably cylindrical so that the flow rate of the insulating liquid 10 conveyed through the receiving space therein can be kept stable and pressure losses can be minimized.

As shown in FIGS. 2 and 3, the insulating liquid header 120 of the present embodiment is formed extending along the width direction D of the slot die 200. Specifically, the insulating liquid header 120 is located at the upper part of the slot die 200 and is formed extending horizontally with the slot die 200.

Each supply pipe 140 connected to the insulating liquid header 120 may be disposed along a direction in which the insulating liquid header 120 is elongated. Specifically, the plurality of supply pipes 140 are spaced apart at predetermined distances and connected to the insulating liquid header 120 in turn. The length and inner diameter of each of the supply pipes 140 are preferably all the same so that the flow rate of the insulating liquid 10 conveyed through each of the supply pipes 140 becomes uniform. In other words, by unifying the dimensions of each of the supply pipes 140, the pressure loss value in each of the supply pipes 140 is uniform. In addition, the supply pipes 140 are preferably equal in regard to other factors that may affect the pressure loss, such as material, etc.

The insulating liquid header 120 may be provided at a position spaced apart in a predetermined distance from the slot die 200 as shown in FIG. 2, but need not be limited thereto and may be attached to the slot die 200.

FIG. 4 is a cross-sectional view of the insulating liquid header 120 of FIG. 3. Referring to FIGS. 3 and 4, the insulating liquid header 120 has an inlet port 121 formed at the lower part through which insulating liquid 10 flows in, and an outlet port 122 formed at the upper part through which insulating liquid 10 flows out.

A transfer pipe 130 connecting the insulating liquid tank 110 and the insulating liquid header 120 is connected with the inlet port 121 of the insulating liquid header 120, and a supply pipe 140 connecting the insulating liquid header 120 and the slot die 200 is connected with the outlet port 122 of the insulating liquid header 120. In this case, the transfer pipe 130 is connected to the lower part of the insulating liquid header 120 and the supply pipe 140 is connected to the upper part of the insulating liquid header 120.

The transfer pipe 130 is preferably connected to a height point H2 that is less than half of the height (inner diameter size) H1 of the insulating liquid header 120, and more preferably connected to a height point that is less than 30% of the height H1 of the insulating liquid header 120. In this way, by ensuring that the transfer pipe 130, i.e., the inlet port 121, is formed at a lower position of the insulating liquid header 120, the bubbles (gas) generated in the insulating liquid header 120 may be removed by causing them to move to the upper part of the insulating liquid header 120.

If the gases generated in the insulating liquid header 120 are not discharged smoothly, the remaining gases may interfere with the flow rate (flow velocity) of the insulating liquid 10 or cause an uneven loading amount when the insulating liquid 10 is discharged. Therefore, by connecting the transfer pipe 130 to the lower part of the insulating liquid header 120 and connecting the supply pipe 140 to the upper part of the insulating liquid header 120, small gases are removed from the insulating liquid header 120 from time to time along with the transfer of the insulating liquid 10. Further, in order to further increase the effectiveness of the gas removal, the supply pipe 140 is preferably connected to the uppermost part of the insulating liquid header 120.

The insulating liquid supplying device 100 of the present embodiment may be further provided with a gas discharge valve or the like at the upper part of the insulating liquid header 120. That is, gases such as air generated inside the insulating liquid header 120 may be discharged to the outside through the gas discharge valve.

The insulating liquid 10, which is introduced through the transfer pipe 130, passes through the internal receiving space of the insulating liquid header 120 and simultaneously flows out through the plurality of supply pipes 140.

The present invention aims to adjust the flow rate of the insulating liquid 10 flowing out of the supply pipes 140 to be constant, so that the insulating liquid 10 is uniformly discharged through each of the outlet ports of the slot die 200.

Accordingly, the height at which each outlet port 122 is formed in the insulating liquid header 120 is preferably the same so that the flow rate of the insulating liquid 10 conveyed through each supply pipe 140 is uniform.

The insulating liquid supplying device 100 of the present invention is adjusted so that the flow rate of the insulating liquid 10 to be moved is all the same in the plurality of supply pipes 140 connected to the insulating liquid header 120 by increasing the pressure loss in the plurality of supply pipes 140 compared to the pressure loss in the insulating liquid header 120. For example, even if the supply pipe 140 is connected to the insulating liquid header 120 at the same height with the same dimensions, a difference in the flow rate of the insulating liquid 10 in each supply piping 140 may occur depending on the distance of the outlet port 122 from the transfer pipe 130, that is, the inlet port 121 of the insulating liquid header 120.

The insulating liquid supplying device 100 according to the first embodiment of the present invention has modified the shape of the supply pipes 140 to increase the pressure loss in the supply pipes 140. Specifically, as shown in FIGS. 2 and 4, the supply pipe 140 has a U-shaped structure that is protruded from the upper part of the insulating liquid header 120 and turns downward to connect with the slot die 200. Preferably, the supply pipe 140 is protruded from the upper part of the insulating liquid header 120 and connected with the slot die 200.

Depending on where the supply pipe 140 is connected to the upper part of the insulating liquid header 120, a difference in flow rate in the supply pipe 140 may occur. For example, if the supply pipe 140 is connected near 60% of the height of the insulating liquid header 120, the insulating liquid 10 conveyed to the supply pipe 140 near the inlet port 121 of the insulating liquid header 120 may be subjected to a relatively stronger pumping pressure from the transfer pump 150. Therefore, in order to minimize the relative influence of the transfer pump 150 as described above, the supply pipe 140 is preferably connected to the uppermost part of the insulating liquid header 120.

In the insulating liquid supplying device 100 of the present invention, the pressure loss of the insulating liquid header 120 and the supply pipe 140 preferably satisfies the condition of the following Equation 1.

(ΔPh/n)<ΔPs*5% [Equation 1]

(In Equation 1, n is the number of transfer pipes connected to the insulating liquid header, ΔPh is the pressure loss inside the insulating liquid header, and ΔPs is the pressure loss of a single supply pipe.)

The insulating liquid header 120 and the supply pipe 140 included in the insulating liquid supplying device 100 according to the first embodiment of the present invention are preferably adjustable in volume, shape, position, inner diameter, and length within the range that satisfies the above Equation 1.

### Second Embodiment

The insulating liquid supplying device 100 according to the second embodiment includes an insulating liquid header 120 arranged to be located at the lower part of the slot die 200.

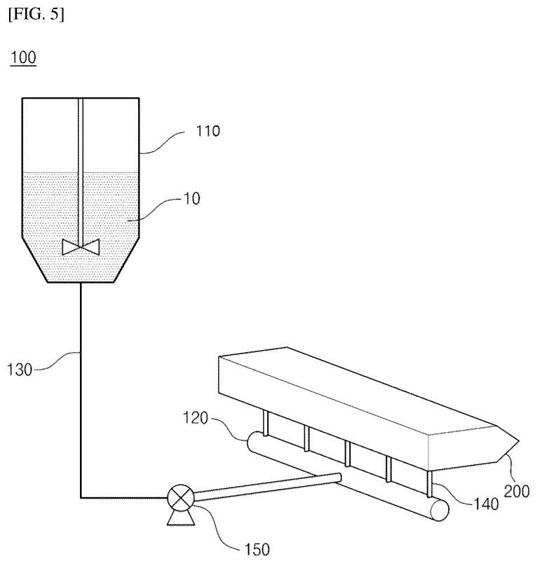

FIG. 5 illustrates the insulating liquid supplying device 100 according to the second embodiment of the present invention.

As shown in FIG. 5, the insulating liquid supplying device 100 according to the second embodiment has an insulating liquid header 120 positioned at the lower part of the slot die 200, and a supply pipe 140 extends from the upper part of the insulating liquid header 120 and is connected to the slot die 200.

Since the supply pipe 140 extends vertically, the resistance encountered by the insulating liquid 10 being transported may be less than the resistance encountered in the first embodiment. Therefore, an inner diameter of the supply pipe 140 of the insulating liquid supplying device 100 according to the second embodiment may be smaller than an inner diameter of the supply pipe 140 of the insulating liquid supplying device 100 according to the first embodiment, and a length of the supply pipe 140 of the insulating liquid supplying device 100 according to the second embodiment may be longer than a length of the supply pipe 140 of the insulating liquid supplying device 100 according to the first embodiment. Alternatively, the volume of the insulating liquid header 120, the inner diameter and length of the transfer pipe 130, and the like may be manipulated so that the pressure loss in the insulating liquid header 120 is less than the pressure loss in the insulating liquid header 120 of the insulating liquid supplying device 100 according to the first embodiment above.

### Third Embodiment

The insulating liquid supplying device 100 according to the third embodiment includes an insulating liquid header 120 located at the rear of the slot die 200 and disposed at the lower part of the slot die 200.

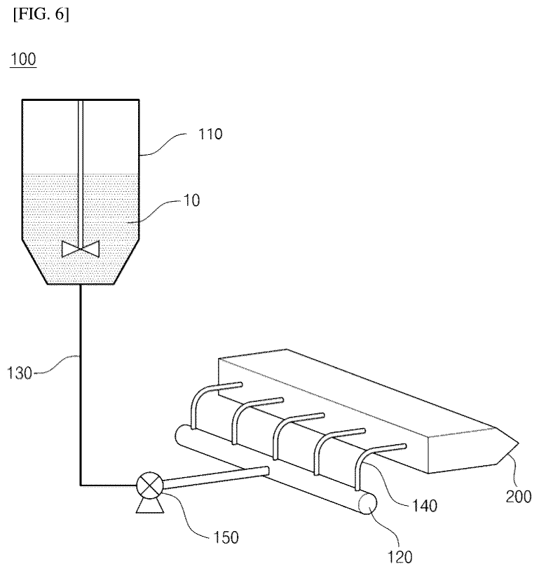

FIG. 6 shows the insulating liquid supplying device 100 according to the third embodiment of the present invention.

As shown in FIG. 6, the supply pipe 140 of the insulating liquid supplying device 100 according to the third embodiment protrudes vertically from the upper part of the insulating liquid header 120, and then bends horizontally toward the rear of the slot die 200.

The supply pipe 140 with such a structure may have a smaller pressure loss than the pressure loss in the first embodiment above, and a larger pressure loss than the pressure loss in the second embodiment above.

### Fourth Embodiment

In the insulating liquid supplying device 100 of the present invention, the insulating liquid 10 can be supplied to the insulating liquid header 120 through a plurality of transfer pipes 130, each of which is equipped with a transfer pump 150. In other words, by increasing the number of paths through which the insulating liquid 10 is transferred to a plurality and equipping each of the transfer pipes 130 with a transfer pump 150, it is possible to transfer the insulating liquid 10 in a short time.

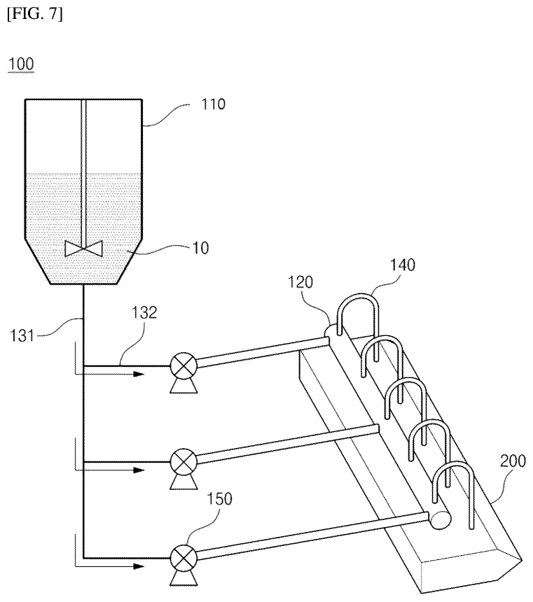

FIG. 7 is an insulating liquid supplying device 100 according to the fourth embodiment of the present invention.

As shown in FIG. 7, in the insulating liquid supplying device 100 according to the fourth embodiment of the present invention, the insulating liquid 10 is transferred from the insulating liquid tank 110 to the slot die 200 by a transfer pump 150 connected to a plurality of pipes, respectively. Specifically, the transfer pipe 130 includes a main transfer pipe 131 connected to the insulating liquid tank 110 and an auxiliary transfer pipe 132 that branches off from the main transfer pipe 131 and connects to the insulating liquid header 120. More specifically, at least two or more auxiliary transfer pipes 132 may branch off from the main transfer pipe 131 in parallel, and each of the branched auxiliary transfer pipes 132 is connected to the insulating liquid header 120. A transfer pump 150 may be provided in each of the auxiliary transfer pipes 132.

Referring to FIG. 7, three auxiliary transfer pipes 132 are connected to one main transfer pipe 131, and three transfer paths are formed by the branched auxiliary transfer pipes 132.

The insulating liquid 10 may be transferred to the insulating liquid header 120 via the three transfer paths, wherein the pressure loss of each auxiliary transfer pipe 132 may vary due to the difference in distance of the transfer paths. Thus, the plurality of auxiliary transfer pipes 132 may be designed to have different lengths depending on the situation. The flow rate of the insulating liquid 10 transferred through each of the auxiliary transfer pipes 132 may vary.

The insulating liquid supplying device 100 of the present embodiment firstly buffers the above differences by temporarily accommodating the insulating liquid 10 transferred through each auxiliary transfer pipe 132 in a single space called the insulating liquid header 120. Secondly, by increasing the pressure loss of the supply pipes 140, the insulating liquid 10 in each of the plurality of supply pipes 140 can all be transferred at the same flow rate.

The insulating liquid supplying device 100 of the present invention can overcome flow unevenness caused by differences in the length of the transfer pipes 130 and the like by adding an insulating liquid header 120 configuration. Furthermore, by limiting the position of the supply pipe 140, it is possible to overcome the flow unevenness phenomenon that may be newly generated by the insulating liquid header 120 configuration.

In addition, the insulating liquid supplying device 100 of the present invention offsets the flow difference caused by the transfer pipe 130 and the insulating liquid header 120 by increasing the pressure loss of the supply pipe 140, and enabling the flow rate of the insulating liquid 10 transferred from the insulating liquid header 120 to each supply pipe 140 to become uniform.

The present invention has been described in more detail above with reference to the drawings and embodiments. However, it is to be understood that the configurations shown in the drawings or embodiments described herein are only exemplary of the invention and do not represent all of the technical ideas of the invention, and that there may be various equivalents and modifications that may be substituted for them at the time of filing.

### IDENTIFICATION OF SELECT REFERENCE NUMERALS

10′: (conventional) INSULATING LIQUID
100′: (conventional) INSULATING LIQUID TANK
200′: (conventional) TRANSFER PIPE
300′: (conventional) TRANSFER PUMP
400′: (conventional) SLOT DIE
10: INSULATING LIQUID
100: INSULATING LIQUID SUPPLYING DEVICE
110: INSULATING LIQUID TANK
120: INSULATING LIQUID HEADER
121: INLET PORT
122: OUTLET PORT
130: TRANSFER PIPE
131: MAIN TRANSFER PIPE
132: AUXILIARY TRANSFER PIPE
140: SUPPLY PIPE
150: TRANSFER PUMP
200: SLOT DIE
210: DISCHARGE FURNACE
D: WIDTH DIRECTION

1. An insulating liquid supplying device for supplying insulating liquid to a slot die for a multi-row simultaneous coating comprising:
an insulating liquid tank configured to receive insulating liquid;
a cylindrical insulating liquid header configured to receive insulating liquid transferred from the insulating liquid tank, and convey the received insulating liquid to a slot die;
a transfer pipe connected to the insulating liquid tank and the insulating liquid header such that insulating liquid can be transferred through the transfer pipe;
a plurality of supply pipes connected to the insulating liquid header and the slot die; and
a transfer pump provided in the transfer pipe configured to provide pressure to transfer insulating liquid from the insulating liquid tank to the slot die, wherein the supply pipes are connected to an upper part of the insulating liquid header.

2. The insulating liquid supplying device of claim 1, wherein
the insulating liquid header extends along a width direction of the slot die.

3. The insulating liquid supplying device of claim 1, wherein
the insulating liquid header extends horizontal to the slot die.

4. The insulating liquid supplying device of claim 1, wherein
the supply pipe protrudes from the upper part of the insulating liquid header and is connected to the slot die.

5. The insulating liquid supplying device of claim 2, wherein
the plurality of supply pipes are disposed along the width direction to connect the insulating liquid header and the slot die.

6. The insulating liquid supplying device of claim 2, wherein
a length and inside diameter of each of the supply pipes are respectively the same.

7. The insulating liquid supplying device of claim 2, wherein
pressure losses in each of the supply pipes are the same.

8. The insulating liquid supplying device of claim 1, wherein
a pressure loss of the insulating liquid header is smaller than a pressure loss of the supply pipe.

9. The insulating liquid supplying device of claim 1, wherein
pressure losses of the insulating liquid header and the supply pipe meet the conditions of the following equation:
$$( Δ Ph / n ) < Δ Ps * 5 \%$$
where n is the number of transfer pipes connected to the insulating liquid header, ΔPh is the pressure loss inside the insulating liquid header, and ΔPs is the pressure loss of a single supply pipe.

10. The insulating liquid supplying device of claim 1, wherein
the transfer pipe is connected to a lower part of the insulating liquid header.

11. The insulating liquid supplying device of claim 1, wherein
the transfer pipe comprises: a main transfer pipe connected to the insulating liquid tank; and an auxiliary transfer pipe branching from the main transfer pipe and connected to the insulating liquid header.

12. The insulating liquid supplying device of claim 11, wherein
at least two or more auxiliary transfer pipes branch off in parallel from the main transfer pipe, and the branched auxiliary transfer pipes connect to the insulating liquid header.

13. The insulating liquid supplying device of claim 12, wherein
a transfer pump is provided in each of the auxiliary transfer pipes.

14. A slot die comprising:
a plurality of outlets configured to discharge insulating liquid at one end, the plurality of outlets connected to an insulating liquid header receiving the insulating liquid, and to receive insulating liquid from each supply pipe by connecting to the insulating liquid header by a plurality of supply pipes.
